(19) United States
(12) Patent Application Publication
(10) Pub. No.: US 2005/0216479 A1
(43) Pub. Date: Sep. 29, 2005

(54) Method, software application and system for incorporating benchmark data into a business software application

(76) Inventors: Marcus Wefers, Heilderberg (DE); Thomas Fleckenstein, Frankenthal (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/504,551

(22) PCT Filed: Feb. 13, 2003
(86) PCT No.: PCT/EP03/01434

§ 371 Date: May 23, 2005

Related U.S. Application Data
(60) Provisional application No. 60/335,840, filed on Dec. 5, 2001.

(51) Int. Cl. G06F 7/00

(52) U.S. Cl. 707/100

(57) ABSTRACT

The Invention relates to an electronic data structure comprising benchmark data, said electronic data structure being a file having a format readable by a SGML-based language. The invention further relates to a method for processing and storing data objects by means of one or more processes running in a computer system having one or more of the electronic data structures comprising a step of incorporating one or more of the benchmark data or benchmark definition contained in said one or more electronic data structures into data structure or into a software for support of business processes.

### BACKGROUND OF THE INVENTION

1. Field of the Invention

The technical field of this invention is in the area of electronic data processing. More particularly, the invention relates to methods, computer program products and systems for automated exchange of benchmarks and benchmark data.

2. Description of the Related Art

A benchmark, in general, is a point of reference by which something can be measured. In surveying, a “bench mark” (two words) is a post or other permanent mark established at a known elevation that is used as the basis for measuring the elevation of other topographical points.

In economic environment, particularly in computer and Internet technology, “benchmark” may have any of these meanings:
A set of conditions against which a product or system is measured. PC magazine laboratories frequently test and compare several new computers or computer devices against the same set of application programs, user interactions, and contextual situations. The total context against which all products are measured and compared is referred to as the benchmark.
A program that is specially designed to provide measurements for a particular operating system or application.
A known product with which users are familiar or accustomed to that other newer products can be compared to.
A set of performance criteria, which a product is expected to meet.

Within the concept of this invention, benchmarks are standards or averages by which similar items can be compared, and benchmark definitions comprise rules for the calculation and interpretation of benchmark data.

Benchmark data has become a critical input factor for performance measurement and strategy management of enterprises. This information is not only used for measurement purposes but also essential to enable a meaningful planning processes. Companies need quality information about their competitors, industry, products, markets etc. Benchmarks can be useful to satisfy such needs, and some companies offer benchmark programs for downloading or a benchmark testing service on their own web site.

Benchmark definitions and data exist in the economy on a horizontal level, e.g. for areas like human resources, and on a vertical level, e.g. focused on industry, products, services, performances. Benchmarks are hereinafter alternatively referred to as “measures”.

However, if a company intends to perform benchmark analyses for its products or services or its performance with respect to its competitors, the company has to get the benchmark definitions or data on its own or has to consult a benchmark provider. This is a time consuming task, even if the company uses an ERP software (enterprise resource planning), especially if the company itself performs the task. Further, a lot of compatibility problems may arise if the data shall be incorporated into the company's ERP software, because each benchmark provider provides its own data format, which does not always fit to the format required by the company's ERP software. A further problem of getting data is that they are not publicly available.

Thus, there is a need for a data structure, method, software application and/or data processing system providing a more efficient solution of the problems described above, particularly it is desirable to provide a data structure and software application for an easy and comfortable exchange or incorporation of benchmarks and benchmark data into a users business software.

### SUMMARY OF THE INVENTION

In accordance with the invention, as embodied and broadly described herein, methods and systems consistent with the principles of the invention provide an electronic data structure comprising benchmark data, said electronic data structure being a file having a format readable by a SGML-based language.

By using the inventive electronic data structure in data processing, benchmark data can be easily exchanged, e.g. between benchmark users and providers. The invention solves the technical problem of establishing an easy path for exchanging electronic data on benchmarks between two computer systems.

In accordance with another aspect, the invention, as embodied and broadly described herein, methods and systems consistent with the principles of the invention provide a method for processing inventive electronic data structures by means of one or more processes running in a computer system having one or more electronic data structures, comprising:
incorporating one or more of the benchmark data or benchmark definition contained in said one or more electronic data structures into data structure or into a software for support of business processes.

The invention is further directed to a computer system, a computer program, a computer readable medium and a carrier signal comprising instructions for processing data according to the inventive method and in its embodiments, respectively.

Additional objects and advantages of the invention will be set forth in part in the description, or may be learned by practice of the invention. The objects and advantages of the invention will be realized and attained by means of the elements and combinations particularly pointed out in the appended claims. Embodiments of the invention are disclosed in the detailed description section and in the dependent claims.

It is understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, explain the principles of the invention. In the drawings,

FIG. 1 is a schematic block diagram of the implementation of the inventive electronic data structure within a computer system.

FIG. 2 is a schematic block diagram of a scenario for selecting a benchmark provider.

FIG. 3 is a schematic block diagram of a scenario for selecting a benchmark package.

FIG. 4 is a schematic block diagram of a scenario for benchmark retrieval.

FIG. 5 is a schematic block diagram of a scenario for customer participation in benchmark study.

FIG. 6 is a schematic block diagram of a scenario for updating benchmark definitions.

FIG. 7 is an exemplary relation among different elements of a structure within an inventive electronic data structure.

### DETAILED DESCRIPTION

Computer and program are closely related. As used hereinafter, phrases, such as “the computer provides” and “the program provides or performs specific actions”, are convenient abbreviation to express actions by a computer that is controlled by a program or to express that the program or program module is designed to enable the computer to perform the specific action.

It should be understood that the term “presentment” as used herein does not include the specialized definition normally associated with commercial paper, i.e. the production on a negotiable instrument to a drawee. Rather, the term refers to providing via electronic means an “electronic data structure”. This electronic presentment may take place through the use of an internet website or e-mail or SMS, a bank ATM machine or through the use of a stand alone kiosk.

Reference will now be made in detail to the principles of the invention by explaining the invention on the basis of a data processing process, examples of which are illustrated in the accompanying drawings. Examples, mentioned therein, are intended to explain the invention and not to limit the invention in any kind.

Within the concept of this invention, the terms used shall have their usual meaning in the context of the field of data processing unless defined otherwise in the following section:

A computer system can be a stand alone computer such as a PC or a laptop or a series of computers connected as a network, e.g. a network within a company, or a series of computers connected via the internet, including any usual peripheral devices, respectively.

A data structure is a specialized format for organizing and storing data. General data structure types include the array, the file, the record, the table, the tree, and so on. Any data structure is designed to organize data to suit a specific purpose so that it can be accessed and worked with in appropriate ways. In computer programming, a data structure may be selected or designed to store data for the purpose of working on it with various algorithms. Within the concept of this invention, an electronic data structure is a data structure stored on a volatile or nonvolatile memory or embedded in a carrier signal and accessible by a computer system.

The term business software shall mean software or software applications or programs or program modules, which support business processes in the economy, particularly in enterprises.

ID is the abbreviation for identifier.

SGML (Standard Generalized Markup Language) is a standard for how to specify a document markup language or tag set. Such a specification is itself a document type definition (DTD). SGML is not in itself a document language, but a description of how to specify one. It is metadata.

SGML is based on the idea that documents have structural and other semantic elements that can be described without reference to how such elements should be displayed. The actual display of such a document may vary, depending on the output medium and style preferences. Some advantages of documents based on SGML are:

They can be created by thinking in terms of document structure rather than appearance characteristics (which may change over time).

They will be more portable because an SGML compiler can interpret any document by reference to its document type definition (DTD).

Documents originally intended for the print medium can easily be re-adapted for other media, such as the computer display screen.

The language that this Web browser uses, Hypertext Markup Language (HTML), example of an SGML-based language, XML is another example. There is a document type definition for HTML (and reading the HTML specification is effectively reading an expanded version of the document type definition).

XML (Extensible Markup Language) is a flexible way to create common information formats and share both the format and the data on the World Wide Web, intranets, and elsewhere. XML can be used by any individual or group of individuals or companies that wants to share information in a consistent way.

XML, a formal recommendation from the World Wide Web Consortium, is similar to the language of today's Web pages, the Hypertext Markup Language. Both XML and HTML contain markup symbols to describe the contents of a page or file. HTML, however, describes the content of a Web page (mainly text and graphic images) only in terms of how it is to be displayed and interacted with. This means that an XML file can be processed purely as data by a program or it can be stored with similar data on another computer or, like an HTML file, that it can be displayed.

XML is “extensible” because the markup symbols are unlimited and self-defining. XML is actually a simpler and easier-to-use subset of the Standard Generalized Markup Language, the standard for how to create a document structure. HTML and XML may be used together in many Web applications. XML markup, for example, may appear within an HTML page.

A first embodiment of the electronic data structure is characterized in that said file is an XML file. An alternative embodiment of the electronic data structure is characterized in that said file is an HTML file. A further embodiment is characterized in that the file further comprises one or more benchmark definitions.

A first embodiment of the inventive method as described in the summary section is characterized in that the method further comprises a step of the incorporation of the benchmark data is performed automatically, comprising the steps of:
reading one or more of said electronic data structures, recognizing one or more key words for benchmark data within one or more of said electronic data structures, writing information, identified by one or more of said key words, into a data base structure.

A second embodiment of the inventive method is characterized in that the method further comprises the incorporation of the benchmark definition is performed automatically, comprising the steps of:
reading one or more of said electronic data structures, recognizing one or more key words for benchmark definition within one or more of said electronic data structures,
writing information, identified by one or more of said key words, into a data base structure.

A third embodiment comprises the information, identified by a key word, and the data base structure, into which said information is written, are assigned to each other by an algorithm.

A further embodiment comprises said algorithm comprises one or more tables or one or more rules.

A further embodiment is characterized by said one or more rules are contained in or more tables.

A further embodiment is characterized in that said data base structure is predefinable.

In a still further embodiment the invention comprises mapping a benchmark data contained in said electronic data structure to an equivalent benchmark data contained in said software for support of business processes by means of a table, in which a first ID of the benchmark data in the electronic data structure is assigned to a second ID of the benchmark data in the software for support of business processes.

A still further embodiment is a the inventive method for use in a software for support of business processes, particularly in an enterprise resource planning software.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer system having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or haptic feedback; and input from the user can be received in any form, including acoustic, speech, or haptic input.

The invention and some of its possible embodiments is now described in more detail by way of reference to the drawings.

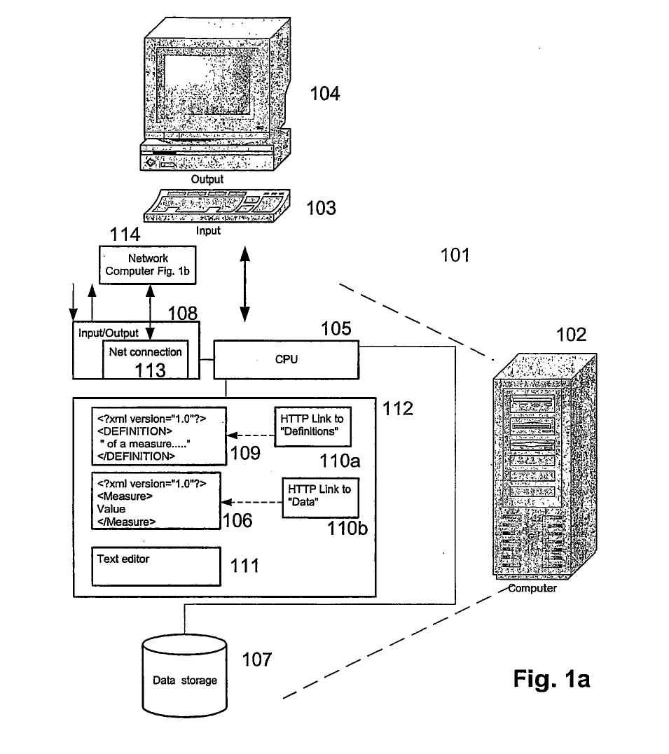

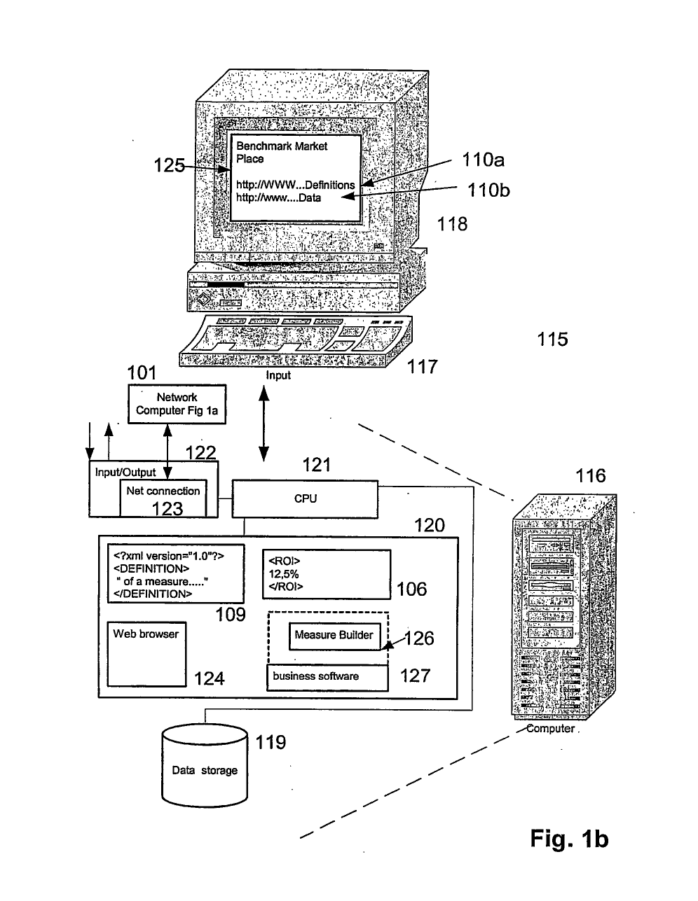

FIGS. 1a and 1b depict one example of an implementation of an embodiment of the invention: a computer system 101 connectable to a computer system 115, each with program modules for performing the inventive method and its implementations. FIG. 1a shows a computer system 101 comprising a computer 102 having a CPU 105, a working storage 112 (memory), in which software applications are stored for being processed by CPU 105. Such a software application may be a text editor 111, for creation of the inventive data structures: a file 109 comprising definitions of benchmarks and a file 106 comprising benchmark data. Computer system 101 further comprises input means 103 and output means 104 for interaction with a user, e.g. for starting programs and/or data input and/or output. Computer system 101 further comprises general input/output means 108, including a net connection 113, for sending and/or receiving data, e.g. for a net connection with one or more further computer systems 114, or for files like the inventive files 106, 109 from other parties. A plurality of computer systems like 101, particularly a computer system 115 as shown in FIG. 1b, may be connected via the net connection 113 in the form of the network 114 in such a case, the network computers 114 can be used as further input/output means, including the use as further storage locations. For storing data, computer system 101 comprises a nonvolatile storage means 107. FIG. 1b shows the computer system 115 connectable to the computer system 101 of FIG. 1a. Computer system 115 comprises a computer 116 having a CPU 121, a working storage 120 (memory), in which software applications are stored for being processed by CPU 121, general input/output means 122, including a net connection 123, for sending and/or receiving data and for a net connection to other computer systems, particularly to computer system 101 of FIG. 1a. Computer system 115 further comprises input means 117 and output means 118 for interaction with a user, e.g. for starting programs and/or data input and/or output, and a nonvolatile storage means 119.

Within the hardware example of FIG. 1a and 1b, the inventive data-structures 106, 109 are installed on the computer system 101. Links 110a, 110b are incorporated in a web page 125, which is accessible via the internet and a web browser 124 and thus enables a second party to process to download (receive) the files 106, 109 by means of computer system 115 when it is connected to computer system 101. The links 110a, 110b and the files 106, 109 may alternatively be sent a third party by other electronic means, like email, SMS.

After receipt of the files 106, 109 a software application 126 (hereinafter referred to as “measure builder”) reads the definition file 109 and recognizes one or more key words for benchmark definitions. The definition identifies information about how to calculate the benchmark. The measure builder then writes the information, identified by one or more of said key words, into a data base structure for access for a software 127, which calculates and/or further processes benchmark data according to the benchmark definition. A user may select which benchmark definitions he wants to have incorporated into his software 127. If the benchmark definitions are then used by software 127 to calculate benchmark data, the calculated benchmark data may be based on business data of the respective company, which uses the system and which are contained in or accessible by software 127. The measure builder 126 may be part of the software 127. In order to correctly recognize the benchmark definitions in file 109, the measure builder may have a list of valid benchmark definitions.

Within the following paragraphs, examples of further implementations of this inventions, possible interactions of a user of a computer system including the data structures and/or methods of the claimed invention (“customer”) are described, without limitation of the invention in any kind.

Terms used:
Benchmark provider A company that offers services to customers such as
   benchmark data, and benchmark definitions (measures)
   participation in benchmark studies,
   consulting,
   advanced analysis of benchmark data
Measure builder Software application for the definition, description and analysis of measures (benchmark definitions). The application offers in further implementations the maintenance and analysis of benchmark data as well.
Measure Catalog Customer defined catalog of measures maintained by the measure builder. A ready to use measures Catalogs is referred to as “Business Content”

In order to satisfy the needs of parties, which use the systems, methods or computer programs according to the present invention, systems, methods or computer programs as claimed may have additional features as described in the following sections:

Thus, the invention comprises a method or module for incorporating external benchmarks into strategy management and performance measurement processes or applications of customers.

The invention further comprises a method or module for the investigation of industry standard measures. This process can be supported by one or more measure catalogs (so-called delivered Business Content) or measure listings of benchmark providers, which have experience in the respective industry or area.

The invention further comprises a method or module for the identifying a subset of those measures meaningful for the company.

The invention further comprises a method or module for identifying appropriate benchmark provider for respective area; by industry, country, product or process.

The invention further comprises a method or module for making benchmark data available for analysis and comparison of actual and plan data against best-in-class, industry average, competitors. The availability of benchmark data for the analysis can be implemented in the following two complementary ways:
1. Transferring external benchmark data from benchmark provider into a benchmark storage. This enables the customer to use them within analytical applications such as a balanced scorecard, management cockpit, value driver trees, business planning & simulation, reporting, financial analytics, customer relationship management analytics, SCM analytics or human capital management analytics.
2. Accessing data directly via web-based services. Some benchmark provider offer in-depth analytical services based on their large benchmark data base. Alternatively, provider may offer their data plus analytical tools via CD delivery for viewing at the customer site.

The invention further comprises a method or module for submitting data to benchmark provider for participation in provider supported survey. This includes the administration and creation of the exchange document based on pre-configurable queries for standard measures.

The invention further comprises a method or module or a further means for enabling the listing of benchmark providers, which supports certain measures. Filters for benchmark provider may be available to provide overview of measure coverage on a provider basis.

The list of providers may be accessible in a convenient location, ideally linked from the measure builder or directly from a web page.

The invention further comprises a method or module or a means for enabling a customer to access a central place (e.g. internet market place), which provides information about benchmark providers that work with certain companies, scope of offering, category of offering (country, industry, special area, validity), web page and license information.

The provider list can be sorted by certain criteria such as industry, country or validity by further. Information about packages that are available for download into the a customer's business software (Customer BS) system may be contained in the provider web page. The user can review those package offerings directly on the web page of the provider and select a package. Such provider web page can be easily accessible.

In order to provide a legal basis for the relation between a provider and a customer, a license agreement may be signed directly between the customer and the provider. This agreement can define e.g. package, number of users, fees and validity.

The invention further comprises a method or module or a further means that enables the identification of users. If named users are required, an easy to use way is provided to the user to communicate the names to the provider, who in return will submit password information etc directly to the user.

Some benchmark providers may require their customer to supply data prior to access information. This can be a very labor-intensive process, which can be shortened significantly by using data collection capabilities and predefined content. The following features support these requirements/specifications:
means for enabling a user to select a survey directly from benchmark provider web page,
means for enabling a review of measures prior to transfer to provider,
means for transferring data to provider in an easy and secure fashion, e.g. by https encryption,
means for providing a transfer receipt to be sent from the provider to the user.

For retrieving benchmark data from provider to a customer's business software system, the invention further comprises a method or module or a means for:
logon handling of provider website;
marking measures or grouping in categories;
enabling secure transfer;
the import of data into customer's business software system, supported by validation check and having viewing capability prior to update;
viewing the history of benchmark transfers.

For application and embedding of external benchmarks, the invention further comprises a method or module or a means for:
reporting of benchmark data in measure builder;
using external benchmarks for analysis with customer's business software, wherein drill-down reporting for detailed analysis may be enabled;

For satisfying needs of providers, the invention further comprises a method or module or a means for:
enabling a customer to send data to provider, e.g. to participate in survey;
handling of mass requests, such as regular updates of data,
means for informing users of updated benchmark data as well as of benchmark definition;
accessing measure ID list, what can serve as the basis to identify measures between a customer's business software system and provider;
promoting offering on web pages;
associating measures with standard measure, e.g. to promote offering;
enabling of drill-down reporting.

The following section describes examples of possible processes of the exchange of benchmark definitions and/or benchmark data between users of the invention with reference to the figures.

The following steps can be used as building blocks of the benchmark exchange.

| | |
|---|---|
| Process 1: | Selection of provider |
| Process 2: | Selection of benchmark package |
| Process 3: | Transfer of benchmark package and update into SEM |
| | benchmark storage |
| Process 4: | Customer Participation in benchmark study |

Explanation of components used in Flow description:

| Component | Description |
|---|---|
| Measure builder | Measure builder at Customer site |
| BW | Underlying business data information system |
| | for a customer business software system |
| XML file containing | Document used for seamless exchange of |
| benchmark data | benchmark data between provider and |
| | customer and vice versa. |
| Benchmarking Website | Listing of benchmark partner companies |
| | including information about their service |
| | offering. This sites allows to browse the |
| | measure available by each individual |
| | provider. Customers can download latest |
| | definitions and descriptions of available |
| | measures used for benchmarking. |
| Benchmark provider | Web-enabled benchmarking application that |
| Website | supports to sign contracts, logon, review |
| | offering, select benchmark packages, |
| | generate XML files, store XML files, |
| | download XML files. |
| Customer BS system | Software system of a customer for |
| | supporting business processes |
| Customer computer | Computer system, which the customer uses to |
| | perform the described actions. |
| Provider computer | Computer system, which the benchmark |
| | provider uses to perform the described |
| | actions. |

Selection of Provider

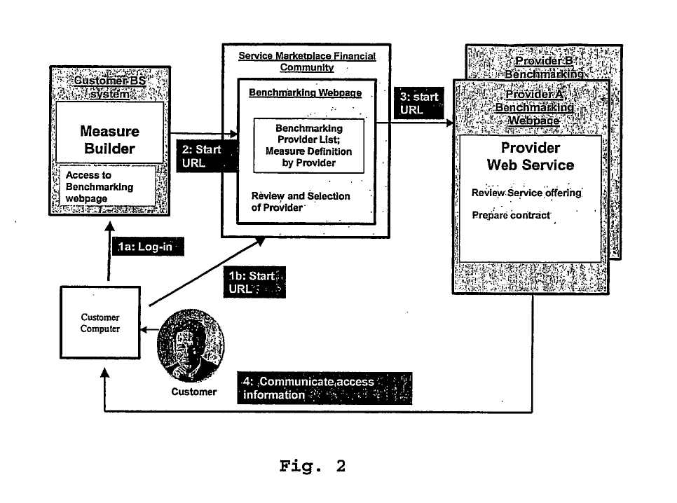

The steps for this process are described in the following table with reference to FIG. 2.

| | Short | |
|---|---|---|
| Step | description | Description and comments |
| 1a | Logon | User logon to measure builder. |
| 1b | Access service | Alternatively, the user accesses the |
| | marketplace | service marketplace. |
| 2 | View list of | The user accesses the service |
| | benchmark | marketplace that includes an additional |
| | providers | page for the benchmark topic. Here the |
| | | user finds a list of benchmark partner |
| | | companies. Also, a list exists that |
| | | allows to view measure definitions |
| | | grouped by each benchmark provider. |
| 3 | Access benchmark | User can review benchmark provider |
| | provider website | service offering, such as benchmark |
| | | data subscription, consulting services. |
| | | This might include viewing of sample |
| | | data or limited access to benchmark |
| | | data base. |
| | | Contract preparation, such as pricing |
| | | models, up to sign-off of contract |
| 4 | Benchmark access | Provider informs customer about access |
| | information | details, like user ID's and passwords |

Selection of Benchmark Package

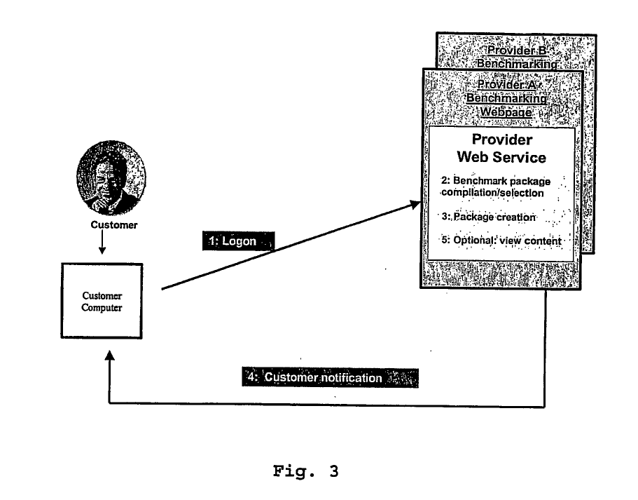

The steps for this process are described in the following table with reference to FIG. 3.

| | Short | |
|---|---|---|
| Step | description | Description and comments |
| 1 | Logon | Customer logon to provider website and |
| | | identification through User-ID and |
| | | password. This logon can be |
| | | accomplished by using a partner URL |
| | | directly, but also via a partner link |
| | | on a third party's benchmarking web |
| | | page. This benchmarking web page can be |
| | | accessed directly, from the measure |
| | | builder. |
| 2 | Benchmark | Selection of predefined benchmark |
| | package | package that for example includes |
| | compilation/ | multiple measures and a given time |
| | selection | interval |
| | | Alternatively, some provider might |
| | | offer an individual and dynamic measure |
| | | selection process through their website |
| 3 | Package creation | Benchmark provider creates the |
| | | requested package (XML file) and stores |
| | | this on the providers web-site |
| | | (technically it will be stored on a |
| | | file server) |
| 4 | Customer | Customer will be notified by email when |
| | notification | package is ready |
| 5 | Optional: View | Provider may offer to view the content |
| | content | of the benchmark package (XML-file) |
| | | directly on their website. |

Transfer of Benchmark Data and Update Benchmark Storage

Customer retrieves benchmark package directly from provider web service. As already described in the selection process, the Customer can access provider's website and choose desired benchmarks from a html page of menu items. After selection, the provider can generate a valid XML document according to the selections of the customer and store this file on a provider fileserver or data base.

The customer will then access the file via a provider web service and download the file locally or to customer fileserver.

The invention further provides parsing and viewing capabilities of the file as well as a mechanism to update the data to a benchmark storage by mapping the XML structure to a benchmark data storage.

The software used by customer and provider with respect to this process are designed such that
1. XML structure is reconciled between customer and external provider company,
2. benchmark and measure identifiers are reconciled between customer and external provider company,
3. customer can activate relevant measures in measure builder,
4. customer can selected benchmark package directly on provider's web page,
5. provider's software has means to generate requested benchmark package according to XML structure.

A benchmarking service contract may have been put in place between customer and benchmark provider, in order to put the benchmark exchange business on a contractual basis.

In an alternative implementation, provider may transfer benchmark file to a file server hosted by an third party. The customer then retrieves data from this fileserver for further processing and update into a benchmark data storage.

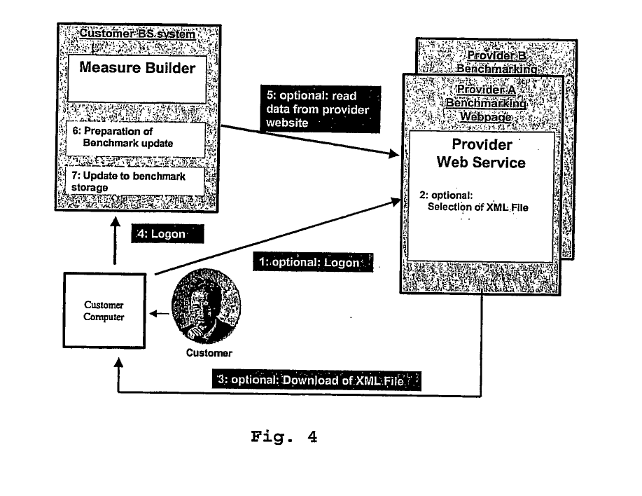

The implementation, in which a customer retrieves benchmark package directly from provider web service is described in the following table with reference to FIG. 4.

| | Short | |
|---|---|---|
| Step | description | Description and comments |
| 1 | Optional step: | Customer logon to provider website and |
| | Logon | identification through User-ID and |
| | | password. This logon can be |
| | | accomplished by using the partner URL |
| | | directly, but also via the partner link |
| | | on a third party's benchmarking web |
| | | page. That benchmarking web page can be |
| | | accessed directly, from the SEM measure |
| | | builder or the third party's website. |
| | | This is an optional step as it's not |
| | | necessary for customer to download XML |
| | | file from provider web site as upload |
| | | program can read provider's website |
| | | directly. |
| 2 | Optional step: | Customer selects XML file that contains |
| | Selection of | requested benchmark package. This may |
| | XML-File | be handled by selecting a file from a |
| | | list or direct access to the file via |
| | | an URL that the provider communicated |
| | | to the customer. |
| | | The provider may also provide viewing |
| | | capabilities for the selected package. |
| 3 | Optional step: | Customer transfers file to storage |
| | Download XML | location on customer side such as local |
| | File | hard drive or customer network folder. |
| | | Alternatively, the file could also be |
| | | sent via a CD or email, depending on |
| | | the providers offerings. FTP could be |
| | | used as well. |
| 4 | Logon to SAP SEM | User logon to SAP SEM measure builder. |
| 5 | Optional: read | Upload program read benchmark XML file |
| | benchmark XML | from provider's website, thus user |
| | file from | doesn't need to download file. But he |
| | provider website | must tell the upload program the URL of |
| | | the benchmark XML file as well as user |
| | | name and password(if required). |
| 6 | Preparation of | From the measure builder, the upload of |
| | benchmark Update | the file will be initiated by selecting |
| | | the file from either the local data |
| | | storage or URL on provider website. |
| | | The file may be validated, parsed and |
| | | mapped to the benchmark data storage |
| | | structure. benchmark data can be |
| | | reviewed in order to verify accuracy |
| | | and relevance prior to update of the |
| | | benchmark data storage |
| 7 | Update | benchmark data will be updated into the |
| | | benchmark storage. |

Customer Participation in Benchmark Study

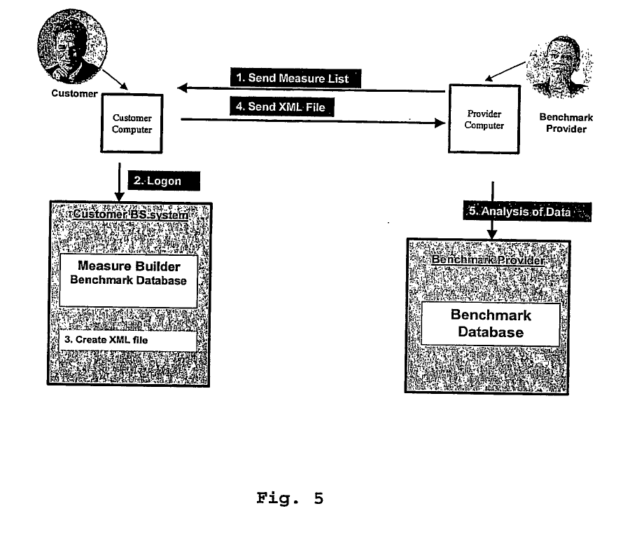

The steps for this process are described in the following table with reference to FIG. 5.

The participation in a benchmark study may be part of a benchmark provider offering. Benchmark study may be defined as the collection and analysis of data for a certain customer group. Benchmark providers may offer this service to enable direct comparison of customer data against sample data but also to further increase the provider data base itself.

A further implementation of the inventive method comprises predefinable query assignment for selectable measures. An assignment of benchmark provider measures to standard measures will allow the customer to use queries for easy data retrieval.

| | Short | |
|---|---|---|
| Step | description | Description and comments |
| 1 | Send measure | Benchmark provider can notify customer |
| | List | what measures and benchmark data are |
| | | required for their study. |
| 2 | Logon SEM system | SEM customer logons SEM system to |
| | | retrieve data for measures |
| 3 | Create XML file | SEM customer reads data from his |
| | | benchmark data storage for measures |
| | | asked by provider and then generates a |
| | | XML file for results. |
| 4 | Send XML file | Once XML file created customer can send |
| | | it to provider via e-mail or ftp. |
| | | Encryptions is highly recommended. |
| 5 | Analysis of data | Benchmark provider receives data and |
| | | analysis of data. The result will be |
| | | written into his own benchmark data |
| | | base. |

Get Latest Update on Providers Measure Definition

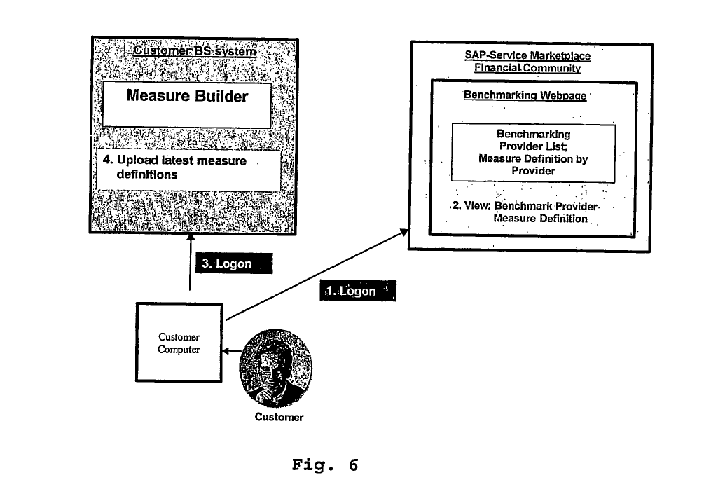

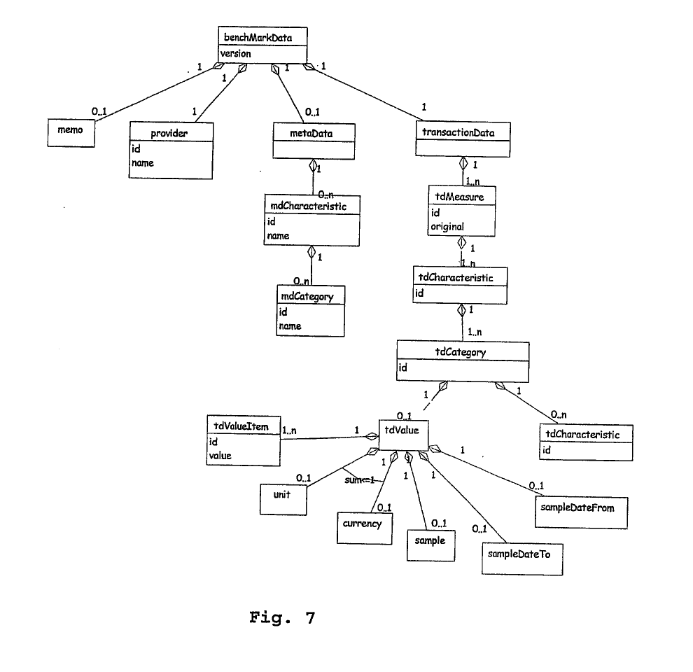

The steps for this process are described in the following table with reference to FIG. 6.

| | Short | |
|---|---|---|
| Step | description | Description and comments |
| 1 | Logon | Customer logon to a financial service |
| | | marketplace. |
| 2 | View pages | Under financial service page, customer |
| | | can view e.g.: |
| | | Benchmark provider list |
| | | Benchmark provider service offerings |
| | | Measure definitions of provider |
| 3 | Logon to SEM | Customer logon to SEM system. |
| | system | |
| 4 | Upload latest | Customer startup process from measure |
| | measure | builder to upload latest measure |
| | definitions | definitions into customer measure |
| | | catalog. |
| | | All latest measure definitions are |
| | | contained in a XML file. |
| | | Upload process reads XML file from |
| | | financial service marketplace. |

Technical Aspects

The following paragraphs describes various technical design issues as they may apply to the benchmarking scenario.

Benchmark definition in measure builder:

The measure builder serves as the library for benchmark definition.

A measure may have the following attributes:
a technical identifier (ID),
a short text and/or long text,
a formula or rule, how it is calculated or calculated from other measures,
unlimited text description,
a data source or reference to a data source,
an assignment to categories, e.g. such as industry or geography.

Measure builder features useful in this context include:
organization of measure hierarchies where measures are linked based on functional areas such as HR, finance and logistic,
link of measures to queries for data retrieval and reporting,
benchmark data reporting based o the benchmark data storage,
ability to apply filter to measures (Filter criteria may be industry, region etc.)

Measures may be grouped into a node within the measure catalog. Measures from benchmark providers may be grouped into dedicated nodes outside a standard measure hierarchy. Those provider measures may carry the same or a similar definition as standard measures. Provider measures may be pointed to standard measures. Benchmark provider measure ID's can be mapped to the technical ID's of measures in the measure builder.

By using data structures, systems and methods according to this invention, third benchmark provider may provide data for a subset of measures, but may also provide data for measures that are not yet part of the measure builder content or measures that have been added to the provider offering lately.

Benchmarking Web Pages

Benchmarking web page may provide access to provider information such as:
basic description of service offering,
URL link to navigate to provider website,
“latest” measure definitions by individual provider.

Design and technical implementation of those services may be customized by the provider. Technical details may vary between the provider, such as how the XML files are delivered to customer, how the logon is handled etc and depend largely on solutions already in place and infrastructure considerations on the provider side. However, these details are within the knowledge of person of ordinary skill.

Benchmark Exchange Protocol

According to this invention, benchmark definitions and data may be exchanged via files in XML format. The XML scheme may be suggested by a customer or a software supplier according to the desired or available structure of the benchmark data storage and reviewed with the benchmark providers. Dimensions such as industry relevance, region, version, time characteristics may be reflected in the scheme.

Provider Web Service

A provider's web page-for exchanging the inventive data structures may offer services like:
logon handling,
enabling a customer to select specific or grouped benchmarks for download,
generating valid XML files according to XML structure, filtering, sorting benchmarks,
Documentation around benchmark service offering.

Import of Benchmark Data

In further implementations of the invention, means are provided for import functionality for:
validation of benchmark XML document,
parsing of imported file,
mapping of data to benchmark data storage,
viewing capability of imported data prior to posting to benchmark data storage,
posting of data to benchmark data storage,
monitoring and logging,
Error handling.

Those capabilities can be accomplished through various combinations of components like:
upload programs of economic software applications,
web application server,
business connector or other middleware functionality,
client-side applications (VB or Java),
browser capabilities, e.g. parsing.

Drill-Down Reporting

In case a first provider will capture only a subset of the data that is generally offered by a second provider.

Further drill-down and additional reporting capabilities might be available on the provider's web page.

Therefore, a drill-down capability into the first provider's web page that allows a customer to navigate to the analytical application of the second provider. The realization of this capability may be handled in several phases. In the first phase, a link to the second provider web page with subsequent logon of the user may be offered.

A dynamic link up to a report to report interface may be addressed in a second phase.

The following example provides an example of guidelines for implementing the inventive data structure. A limitation of the invention in any kind is not intended.

The inventive measure builder enables an enterprise, who uses this tool, for example to upload benchmarks and benchmark data and to compare benchmark data with their own company data.

A lots of benchmark providers in the market, do benchmark studies and send study result to their customers.

Any benchmark provider, who wants to provide benchmark data that a customer having a business software can upload directly into his system, can now according to the invention organize his benchmark data in a XML file that follows a structure as designed below.

Structure Outline

Root Element

The root element of the XML document is named as “benchMarkData”.

Five parts may be included in the root element:
Memo, Provider, Meta Data, Measure ID and Transaction Data

Memo

Element memo is description for benchmark provider to add notes to this XML document.

Memo is optional element.

Meta Data type is defined by element mdCharacteristic, concrete meta data is defined by element mdCategory.

Provider

Element provider is used to define benchmark provider.

Each Benchmark Data Entry posted into business software system may be identified by benchmark provider.

Here is an example for provider element:
<provider id=“FOO” name=“Foo company”/>

Value of Attribute “id” identifies provider. Value of attribute “name” is description of provider, it's optional.

Another usage of provider's id is as prefix to provider measure id, which is explained below in more detail.

Meta Data

Element metaData defines provider meta data, i.e. classification standard, for example, industry category such as banking, chemical, education, etc.

It's optional for provider to include meta data in their Benchmark XML file.

Following pieces show how to define a meta data type as well as it's meta data:

```
<metaData>
  ...
  <mdCharacteristic id=“0INDUSTRY” name=“Industries”/>
    <mdCategory id=“BANK” name=“Banking”/>
    <mdCategory id=“CHEM” name=“Chemicals”/>
  ...
  </mdCharacteristic>
  <mdCharacteristic id=“0UNIT” name=“Unit of measure”/>
  ...
</metaData>
```

<metaData> begins definition of provider meta data. <mdCharacteristic id=“0INDUSTRY” name=“Industries”/> begins meta data entries for a specific meta data type. Value of Attribute “id” identifies meta data type. Value of attribute “name” is for meta data type definition, it's optional. For valid meta data type refers to section 2.6.
<mdCategory id=“BANK” name=“Banking”/> defines one meta data for the above given meta data type. Value of attribute “id” gives technical name of meta data; value of attribute “name” is meta data description. <mdCategory id=“CHEM” name=“Chemicals”/> is another meta data for the above given meta data type.
. . .
</mdCharacteristic> ends definition of meta data for 0INDUSTRY.
</metaData> ends definition of provider meta data.

The meta data types are not random defined. The supported meta data types are listed below.

Measure ID (Identifier)

It's difficult for provider to define measure id-in XML document.
If provider wants to use their own measure id in XML document, then the following steps are advisable:
Send a document including a measure list to a third person who manages measure id.
Said third person give a unique name the benchmark provider as his identifier in element <provider> Provider's measure are created by adding the unique name as well as two separator‘\’, before and after the unique name, thus unique measure name is guaranteed
Publish provider measure definition onto a Service Marketplace
Customer download provider's measure definition into their SEM system
Customer link provider measure to their company measure or
Customer activate provider-measure as their company measure
When generating of benchmark.value xml document, define provider's id as the above unique provider name

While reference to measure, just use the original measure id.

The reference to measure is defined by element <tdMeasure>.

If you want to refer to a original measure 1001, then define element like: <tdMeasure id=“1001”>

In some cases provider and customer may achieve agreement to use customer's measure id, for example, customer has one measure ‘CUST_{—}0001’, then refer to this measure like:
<tdMeasure id=“CUST_{—}1001” original=“N>

Provider's id may be defined as agreed unique name in the second step if it is required to use the original measure id in the xml document.

Name restriction to provider's original measure id may be:
Only alphanumeric and ‘_’ are allowed in measure name, length may be lees than 11.

Transaction Data

Element transactionData contains benchmark data entries to be posted into customer SEM system.

It's advantageous to have at least one entry in transaction data, or else it doesn't make sense to delivery such XML file to customer.

Following pieces show exemplary how to define benchmark data for a measure turn over rate (measure id 1001):

```
<transactionData>
  <tdMeasure id=“1001”>
      <tdCharacteristic id=“0CALYEAR”>
        <tdCategory id=“1999”>
    <tdCharacteristic id=“0BM_S_TYPE”>
            <tdCategory id=“GRO”>
              <tdCharacteristic id=“0BM_S_RANGE”>
                <tdCategory id=“H”>
                  <tdValue>
                    <tdValueItem
  id=“25%”>0.159</tdValueItem>
                    <tdValueItem
  id=“MED”>0.22</tdValueItem>
                    <tdValueItem
  id=“75%”>0.38</tdValueItem>
                    <unit>%</unit>
                  </tdValue>
                </tdCategory>
                <tdCategory id=“M”>
                  ...
        ...
      </tdMeasure>
      ...
    </transactionData>
    <transactionData> begins definition for benchmark
    data entries.
<tdMeasure id=“1001”> begins benchmark data entries
for measure \FOO\1001
<tdCharacteristic id=“0CALYEAR”> together with
<tdCategory id=“1999”> defines header meta data
calendar year :1999. For valid meta data type refers
to section 2.6
<tdCharacteristic id=“0BM_S_TYPE”> together with
<tdCategory id=“GRO”> defines header meta data
company size type: revenue growths.
<tdCharacteristic id=“0BM_S_RANGE”> together with
<tdCategory id=“H”> defines header meta data company
size range: high revenue growths.
```

<tdValue>begins definition of entry items. And up to now we have header data like below:

| | Calendar | Company | Company size |
|---|---|---|---|
| Measure ID | Year | size type | range |
| 0HR_HRMC_006 | 1999 | GRO | H |

<tdValueItem id=“25%”>0.159</tdValueItem> benchmark value 0.159 for benchmark version “25%”.
<tdValueItem id=“MED” >0.22</tdValueItem>benchmark value 0.22 for benchmark version “MED”.
<tdValueItem id=“75%”>0.38</tdValueItem>benchmark value 0.38 for benchmark version “75%”.
<unit>%</unit>benchmark value unit is %.

</tdValue> ends definition of entry items. Up to now we have three entries like below:

| | | | Company | | | |
|---|---|---|---|---|---|---|
| | Calendar | Company | size | Benchmark | | |
| Measure ID | Year | size type | range | Version | Unit | Value |
| 0HR_HRMC_006 | 1999 | GRO | H | 25% | % | 0.159 |
| OHR_HRMC_006 | 1999 | GRO | H | MED | % | 0.22 |
| OHR_HRMC_006 | 1999 | GRO | H | 75% | % | 0.38 |

</tdCategory>
<tdCategory id=“M”> begins definition of benchmark
data entries that have the same measure id, calendar
year, company size type but with different company
size range.
...
</tdMeasure> ends definition for benchmark data entries
for measure 0HR_HRMC_006.
...
</transactionData> ends definition for
benchmark data entries

Any number of meta data types as many as are needed can be defined for benchmark data entries.

Meta Data Types

In the table below meta data types are listed.

TABLE 1
meta data types

| Meta data | | |
|---|---|---|
| type id | Description | Examples |
| 0MEASURE | Measure | ROCE; NOPAT; FTE |
| 0BM_VERSION | Benchmark Version | 25% percentile; |
| | | best in class |
| 0INDUSTRY | Industry | Banking; Education |
| 0COUNTRY | Country | Germany; France |
| 0BM_PROVIDE | Benchmark Value | InfoHRM; PMG; Self |
| | Provider | |
| 0BM_REGION | Geographic region | Middle Europe; East |
| | | North Asia |
| 0BM_COMPANY | Company | X; Y; Z |
| 0BM_S_TYPE | Company size type | Revenu; Employee |
| | | numbers |
| 0BM_S_RANGE | Company size range | 5 m-10 m; 1000-5000 |
| 0UNIT | Unit for measure | %; Ratio |
| | quantity | |
| 0CURRENCY | Currency for | USD; DEM; EURO |
| | measure amount | |
| 0CALMONTH2 | Calendar month with | 01; 02; 11 |
| | two digits | |
| 0CALMONTH | Calendar Year/ | 200001; 200112 |
| | Month | |
| 0CALQUART1 | Calendar quarter | 1; 2; 3; 4 |
| | with one digit | |
| 0CALQUARTER | Calendar Year/ | 200101; 200102; |
| | Quarter | 200103; 200104 |
| 0CALYEAR | Calendar year with | 2000; 2001 |
| | four digits | |
| 0FISCPER | Fiscal year period | 2000001; 2001002 |
| 0FISCPER3 | Fiscal year period | 001; 002 |
| 0FISCYEAR | Fiscal Year | 1999; 2000; 2001 |
| 0FISCVARNT | Fiscal Year Variant | K4 |
| 0BM_VALID_F | Benchmark Valid | 20010101 |
| | Date From | |
| 0BM_VALID_T | Benchmark Valid | 20011231 |
| | Date To | |

Provider is able to define meta data for all listed meta data types except for the first one 0MEASURE as measure can be defined via Measure Builder.

When defining data entry for benchmark values, meta data may be referenced by different ways:
1. Measures are identified by attribute “id” of element tdMeasure;
2. Benchmark provider is identified by element provider.
3. Units are identified by element unit;
4. Currencies are identified by element currency;
5. Benchmark versions are identified by attribute “id” of element tdValueItem;
6. For other meta data types, meta data are identified by attribute “id” of both element tdCharacteristic and tdCategory.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

Computer programs based on the written description and flow charts of this invention are within the skill of an experienced developer.

1-4. (canceled)

5. A method for processing electronic data structures, the electronic data structures comprising benchmark data and having a file format readable by a SGML-based language, the method comprising:
incorporating one or more of the benchmark data or benchmark definitions contained in said one or more electronic data structures into data structures or into software for supporting business processes.

6. The method of claim 5, wherein the incorporation of the benchmark data is performed automatically, and further wherein the method comprises the steps of:
reading one or more of said electronic data structures;
recognizing one or more key words for benchmark data within one or more of said electronic data structures; and
writing information, identified by one or more of said key words, into a data base structure.

7. The method of claim 5, wherein the incorporation of the benchmark definition is performed automatically, and further wherein the method comprises the steps of:
reading one or more of said electronic data structures;
recognizing one or more key words for benchmark definition within one or more of said electronic data structures; and
writing information, identified by one or more of said key words, into a data base structure.

8. The method of claim 6 or 7, wherein the information, identified by a key word, and the data base structure, into which said information is written, are assigned to each other by an algorithm.

9. The method of claim 8, wherein said algorithm comprises one or more tables or one or more rules.

10. The method of claim 9, wherein said one or more rules are contained in or more tables.

11. The method of claim 7, wherein said data base structure is predefinable.

12. The method of claim 5, further comprising:
mapping benchmark data contained in said electronic data structure to equivalent benchmark data contained in said software for supporting business processes by means of a table, in which a first ID of the benchmark data in the electronic data structure is assigned to a second ID of the benchmark data in the software for support of business processes.

13. The method of claim 5, wherein the method is for use with software for supporting business processes, the software comprising enterprise resource planning software.

14. A computer system for processing electronic data structures, the electronic data structures comprising benchmark data and having a file format readable by a SGML-based language, the computer system comprising:
memory having program instructions;
input means for entering data;
storage means for storing data; and
a processor responsive to the program instructions for;
incorporating one or more of the benchmark data or benchmark definitions contained in said one or more electronic data structures into data structures or into software for supporting business processes.

15. The computer system of claim 14, wherein the incorporation of the benchmark data is performed automatically, and wherein the computer system further comprises:
means for reading one or more of said electronic data structures;
means for recognizing one or more key words for benchmark data within one or more of said electronic data structures; and
means for writing information, identified by one or more of said key words, into a data base structure.

16. The computer system of claim 14, wherein the incorporation of the benchmark definition is performed automatically, and further wherein the computer system comprises:
means for reading one or more of said electronic data structures;
means for recognizing one or more key words for benchmark definition within one or more of said electronic data structures; and
means for writing information, identified by one or more of said key words, into a data base structure.

17. The computer system of claim 15 or 16, wherein the information, identified by a key word, and the data base structure, into which said information is written, are assigned to each other by an algorithm.

18. The computer system of claim 17, wherein said algorithm comprises one or more tables or one or more rules.

19. The computer system of claim 18, wherein said one or more rules are contained in or more tables.

20. The computer system of claim 16, wherein said data base structure is predefinable.

21. The computer system of claim 14, further comprising:
means for mapping benchmark data contained in said electronic data structure to equivalent benchmark data contained in said software for supporting business processes by means of a table, in which a first ID of the benchmark data in the electronic data structure is assigned to a second ID of the benchmark data in the software for support of business processes.

22. The computer system of claim 14, wherein the computer system is for use with software for supporting business processes the software comprising enterprise resource planning software.

23. A computer readable medium comprising instructions for processing electronic data structures, the electronic data structures comprising benchmark data and having a file format readable by a SGML-based language, the instructions comprising instructions for:
incorporating one or more of the benchmark data or benchmark definitions contained in said one or more electronic data structures into data structures or into software for support of business processes.

24. The computer readable medium of claim 23, wherein the incorporation of the benchmark data is performed automatically, and further wherein the computer readable medium comprises instructions for:
reading one or more of said electronic data structures;
recognizing one or more key words for benchmark data within one or more of said electronic data structures; and
writing information, identified by one or more of said key words, into a data base structure.

25. The computer readable medium of claim 23, wherein the incorporation of the benchmark definition is performed automatically, and further wherein the computer readable medium comprises instructions:
reading one or more of said electronic data structures;
recognizing one or more key words for benchmark definition within one or more of said electronic data structures; and
writing information, identified by one or more of said key words, into a data base structure.

26. The computer readable medium claim 24 or 25, wherein the information, identified by a key word, and the data base structure, into which said information is written, are assigned to each other by an algorithm.

27. The computer readable medium of claim 26, wherein said algorithm comprises one or more tables or one or more rules.

28. The computer readable medium of claim 27, wherein said one or more rules are contained in or more tables.

29. The computer readable medium of claim 25, wherein said data base structure is predefinable.

30. The computer readable medium of claim 23, further comprising instructions for:
mapping benchmark data contained in said electronic data structures to equivalent benchmark data contained in said software for supporting business processes by means of a table, in which a first ID of the benchmark data in the electronic data structure is assigned to a second ID of the benchmark data in the software for support of business processes.

31. The computer readable medium of claim 23, wherein the computer readable medium is for use with software for supports business processes, the software comprising enterprise resource planning software.

32. A computer data signal embodied in a carrier wave comprising: code for processing electronic data structures, the electronic data structures comprising benchmark data and having a file format readable by a SGML-based language, said code comprising instructions for:
incorporating one or more of the benchmark data or benchmark definitions contained in said one or more electronic data structures into data structures or into software for support of business processes.

33. The computer data signal of claim 32, wherein the software for supporting business processes comprises enterprise resource planning software.
